(19) United States
(12) Patent Application Publication
(10) Pub. No.: US 2008/0085099 A1
(43) Pub. Date: Apr. 10, 2008

(54) MEDIA PLAYER APPARATUS AND METHOD THEREOF

(76) Inventor: Herve Guihot, Palo Alto, CA (US)

Correspondence Address: NORTH AMERICA INTELLECTUAL PROPERTY CORPORATION, P.O. BOX 506, MERRIFIELD, VA, 22116, US

(21) Appl. No.: 11/538,801

(22) Filed: Oct. 4, 2006

(51) Int. Cl. H04N 7/00

(52) U.S. Cl. 386/95

(57) ABSTRACT

A method for playing a media source includes: extracting a reference subtitle stream from the media source, the reference subtitle stream being synchronized with a multimedia data stream of the media source; matching the reference subtitle stream to a substitute subtitle stream from a subtitle source for generating an output subtitle stream; and playing the multimedia data stream and the output subtitle stream synchronously.

### BACKGROUND OF THE INVENTION

1. Field of the Invention

The present invention relates to subtitle display. More particularly, the present invention relates to switching a set of subtitles to an alternative language from an external source.

2. Description of the Prior Art

Subtitles are a common feature available on many forms of video playback. Subtitles are usually a textual display of dialogue found in film and television to help viewers understand and follow a video. They can be in the primary language of the video, or in an alternate foreign language. Subtitles can also aid viewers with hearing impairments to understand and follow on-screen dialogue. Several TV, DTV, DVD, and satellite broadcasts additionally contain a subtitle reference stream to compliment the primary audio-visual data stream. The reference stream contains the subtitle captions to be displayed synchronously onto the screen with the spoken dialogue. For example, a music video may have subtitles that show the lyrics of the song synchronized with the timing of the music video. Subtitles in a movie would simply display the spoken text of each person while they talk on screen.

One common use of subtitles is to translate or interpret the spoken language of an audio-visual stream from an original language into an alternate language. This allows someone watching a video, who may not understand the original language of the video, to understand and concurrently follow dialogue of the video as it is played. For example, if an English viewer is watching a French film, English subtitles would help him/her to understand and follow the French dialogue.

Due to the limited space of related video storage mediums (DVDs, CDs, tapes etc . . . ), most videos have a limited selection of subtitle files. Also, video broadcasts only transmit a limited set of subtitle files due to bandwidth constraints or lack of demand for certain subtitle languages. Therefore, when watching a video from a storage medium, a viewer cannot select an alternate set of subtitles unless it is made available on the video storage medium. When watching from a video broadcast, the viewer cannot select subtitle sets unless it is transmitted with the broadcast.

### SUMMARY OF THE INVENTION

A preferred embodiment according to the invention is a method for playing a media source like a movie via TV broadcasting. The method includes extracting a reference subtitle stream from the media source. The reference subtitle is of a default language and synchronized with a multimedia data stream, e.g. a video portion of the media source. In addition, the method includes matching the reference subtitle stream to a substitute subtitle stream so as to generate an output subtitle stream to replace the original reference subtitle stream. In implementation, an intermediate subtitle can be used as a medium for associating the reference subtitle stream. Alternatively, timestamps can also be used for synchronizing the reference subtitle stream and the substitute subtitle stream.

The method can be implemented in an electronic system and can also be implemented into corresponding program codes sold to end customers to be installed on their computers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a general inventive concept of the invention;

FIG. 2 illustrates a first embodiment of FIG. 1;

FIG. 3a illustrates a real example of FIG. 2;

FIG. 3b is a continuation of the example in FIG. 3a;

FIG. 4 illustrates a second embodiment of FIG. 1;

FIG. 5 illustrates a real example of FIG. 4;

FIG. 6 is an example of a media player apparatus;

FIG. 7 is a flowchart of operation of the media player apparatus of FIG. 6;

FIG. 8 is an example of reference subtitle, which is divided into a series of scenes;

FIG. 9 is a diagram illustrating relationship between a reference subtitle stream and an intermediate subtitle stream;

FIG. 10 is an example of a file storing intermediate subtitle streams and several candidate subtitle streams that can be selected as a substitute subtitle stream;

FIG. 11 illustrates an example of relationship among the reference subtitle stream, the intermediate subtitle stream and the substitute subtitle stream; and

FIG. 12a illustrates a design example of TV application;

FIG. 12b illustrates a design example of DVD application;

FIG. 12c illustrates a design example of Video over IP application; and

FIG. 12d illustrates a design example of analog cable application.

### DETAILED DESCRIPTION

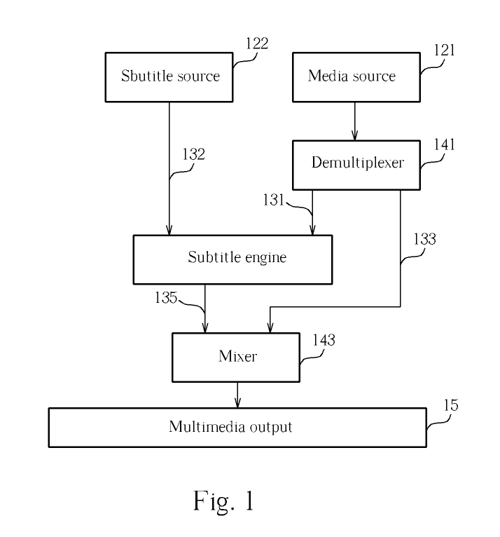

FIG. 1 is a diagram illustrating a general inventive concept according to the invention. A media source 121, e.g. a TV broadcast signal, supplies a data stream containing a reference subtitle stream and a multimedia data stream. In addition, the reference subtitle stream is already synchronized with the multimedia data stream. A de-multiplexer 141 extracts the reference subtitle stream 131 and the multimedia data stream 133 from the media source 121. A subtitle engine 142 matches the reference subtitle stream 131 to a substitute subtitle stream 132 from a subtitle source 122 for generating an output subtitle stream 135. A mixer 143 merges the output subtitle stream 135 with the multimedia data stream 133 to generate a multimedia output 15, e.g. a video program with subtitles viewable by users. The de-multiplexer 141, the subtitle engine 142 and the mixer 143 can be implemented in hardware, software or various combinations of hardware and software for providing corresponding functions.

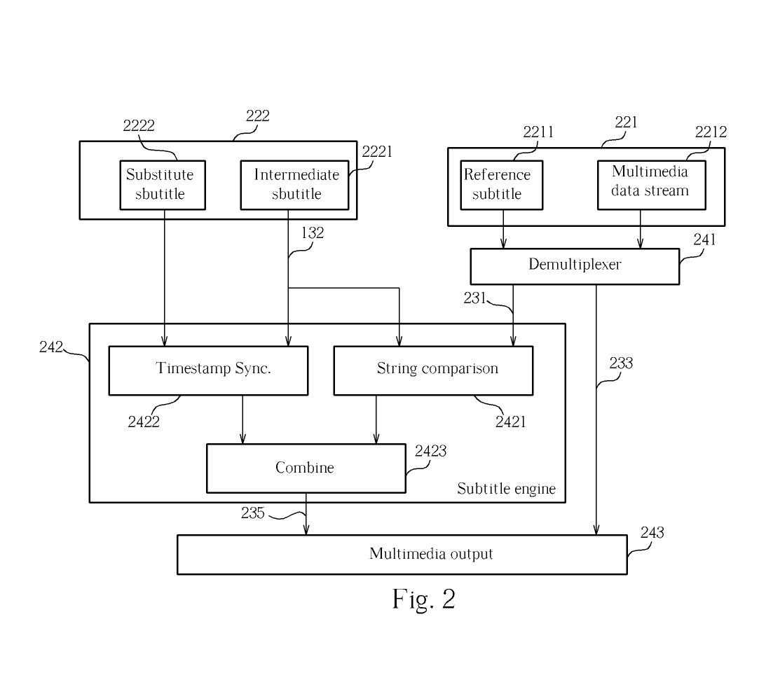

FIG. 2 illustrates a first embodiment of FIG. 1. In this embodiment, a media source 221 contains a reference subtitle stream 2211 and one or more multimedia data stream 2212. A de-multiplexer 241 extracts the reference subtitle stream 2211 and the multimedia data stream 2212 from the media source 221. In addition to the extracted reference subtitle stream 231, a subtitle engine 242 receives an intermediate subtitle stream 2221 and a substitute subtitle stream 2222 from a subtitle source 222. The intermediate subtitle stream 2221 and the reference subtitle stream 231 are of a first language, e.g. English. The substitute subtitle stream 2222 is of a second language different from the first language, e.g. French. The subtitle engine 242 generates an output subtitle stream 235 of the second language to replace the subtitle of its original language.

To perform the substitution, the subtitle engine 242 contains three function blocks. A string comparison block 2421 compares the reference subtitle stream 231 with the intermediate subtitle stream 2221. Since the reference subtitle stream 231 and the intermediate subtitle stream 2221 are of the same language, string comparison associates the reference subtitle stream 231 and the intermediate subtitle stream 2221. Even the reference subtitle stream 231 and the intermediate subtitle stream 2221 are not identical, string comparison can be used for finding identical segments between the reference subtitle stream 231 and the intermediate subtitle stream 2221.

On the other hand, a timestamp synchronization block 2422 identifies relationship between the intermediate subtitle stream 2221 and the substitute subtitle stream 2222. In this example, the intermediate subtitle stream 2221 is already synchronized with the substitute subtitle stream 2222 using timestamps. By checking the timestamps, the intermediate subtitle stream 2221 and the substitute subtitle stream 2222 are associated.

Since the connection between the reference subtitle stream 231 and the intermediate subtitle stream 2221 is available. Also, the connection between the intermediate subtitle stream 2221 and the substitute subtitle stream 2222 is available. Thus, a combination block 2423 is used for combine these two connections and generates an output subtitle stream 235 of the second language to replace the reference subtitle stream 231 of the first language in the final output rendered by a mixer 243.

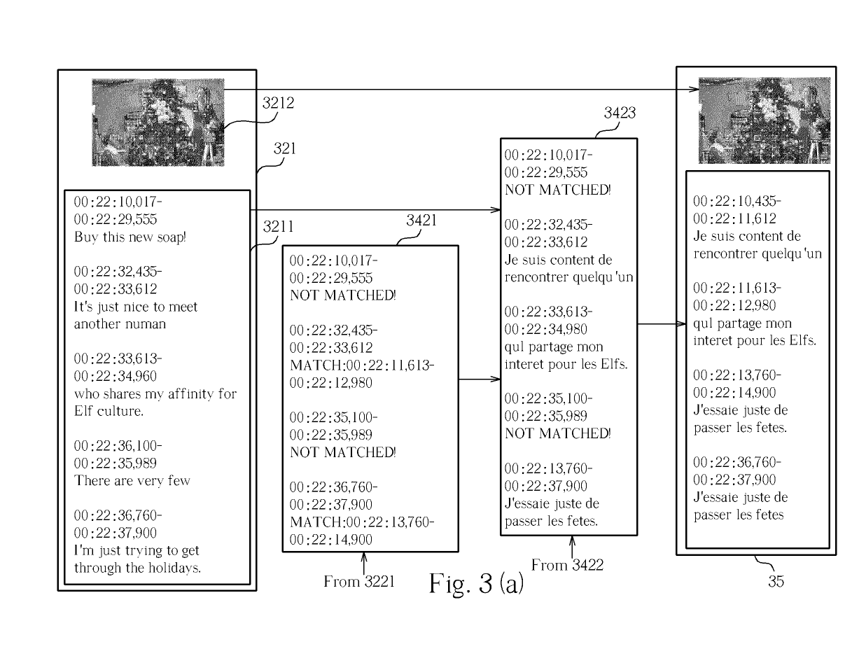

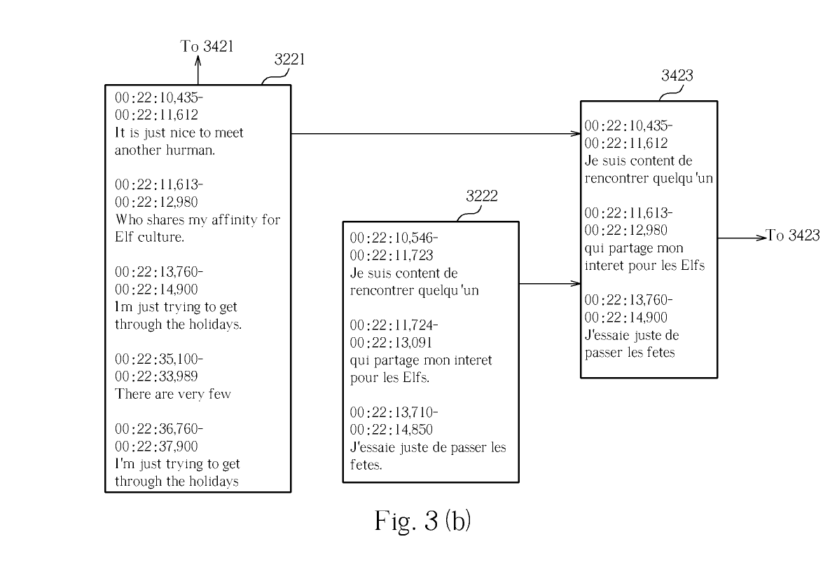

FIGS. 3a and 3b illustrates a real example of FIG. 2. A video program 321 contains a video portion 3212 and a reference subtitle 3211. A subtitle source contains an intermediate subtitle 3221 and a substitute subtitle 3222 (See FIG. 3b). The reference subtitle 3211 is synchronized with the video portion 3212 and of the language of English the same as the intermediate subtitle 3221. The intermediate subtitle 3221 is synchronized with the substitute subtitle 3222. As mentioned above, the relationship between the reference subtitle 3211 and the intermediate subtitle 3221 is found using string comparison. In this example, the reference subtitle 3211 and the intermediate subtitle 3221 are not identical, but they have identical string subsets found from string comparison. In addition, the intermediate subtitle 3221 and the substitute subtitle 3222 are synchronized using timestamps. An example of such timestamps is like the ones illustrated in FIG. 3, e.g. “00:22:10 435-00:22:11.612”. With the relationship among the reference subtitle 3211, the intermediate subtitle 3221 and the substitute subtitle 3222, an output subtitle 3423 that is synchronized with the video portion 3212 is found and mixed with the video portion 3212 to generate a multimedia output 35.

In this preferred embodiment, the intermediate subtitle stream serves as a medium for combining the substitute subtitle stream and the reference subtitle stream. If the substitute subtitle stream already contains timestamp information that can be used for synchronizing the reference subtitle stream and the substitute subtitle stream, the intermediate subtitle stream is not necessary.

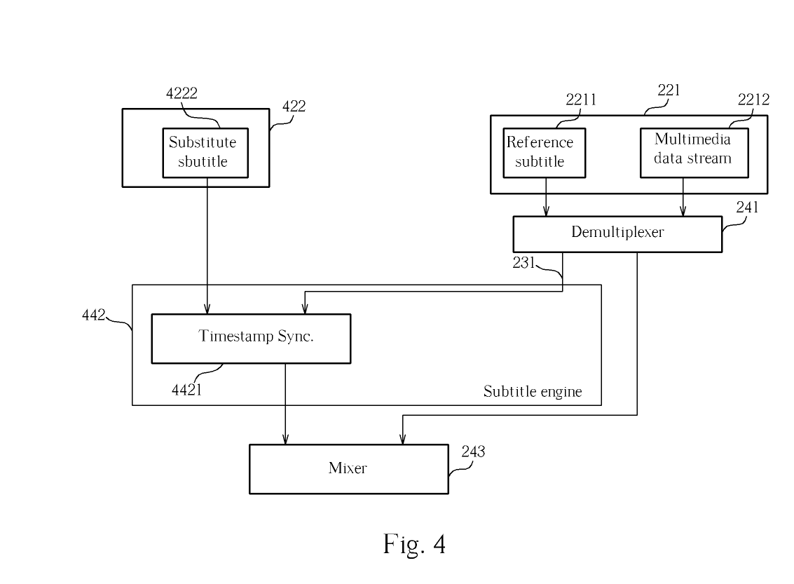

FIG. 4 illustrates a second embodiment of FIG. 1. Blocks with the same reference numerals as that in FIG. 2 refer to the same blocks and no further description is repeated here. In this embodiment, no intermediate subtitle stream is necessary. A subtitle source 422 only contains a substitute subtitle stream 4222. The substitute subtitle stream 4222 is synchronized with the extracted reference subtitle stream 231. Via timestamp synchronization block 4421 in a subtitle engine 442, the substitute subtitle stream 4222 replaces the original reference subtitle stream 231 to be combined with the multimedia data stream with the mixer 243.

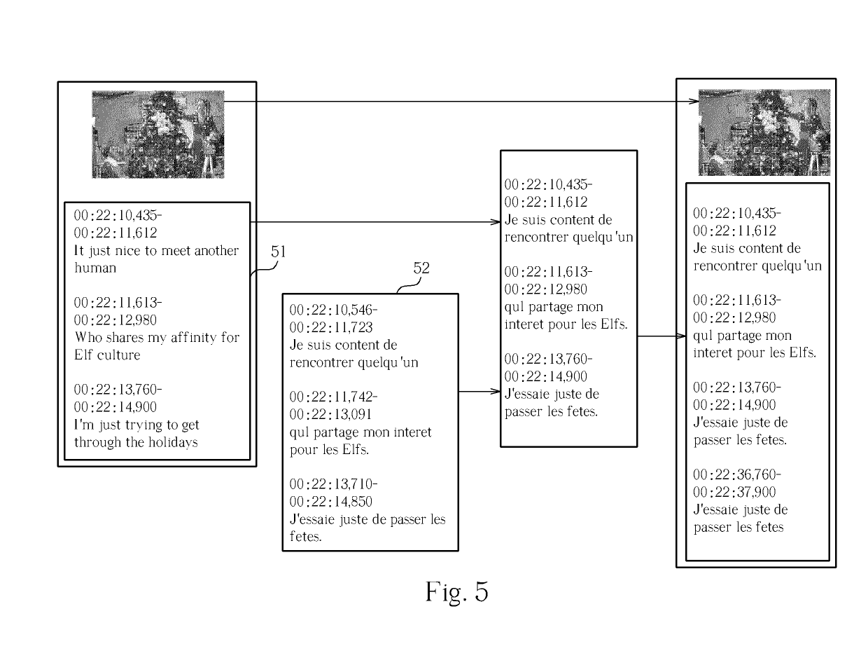

FIG. 5 illustrates an example of FIG. 4. In this example, a reference subtitle 51 of English is synchronized directly with the substitute subtitle 52 of French for providing French subtitle video output.

The following provides a more detailed example for explaining the inventive concept.

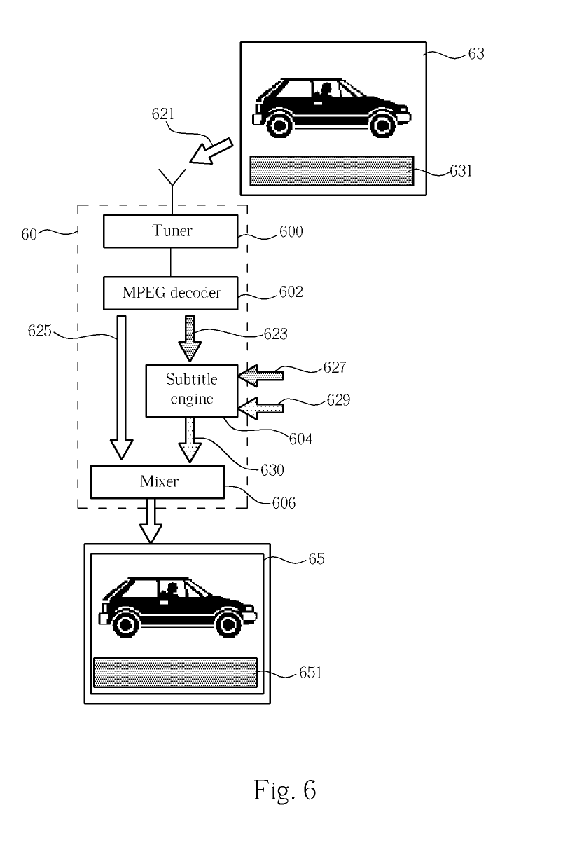

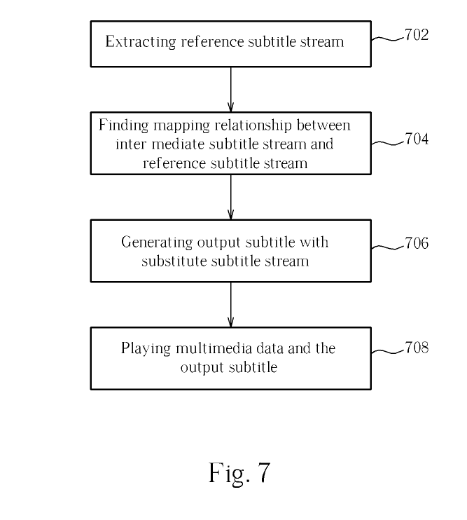

FIG. 6 is a diagram illustrating a media player apparatus 60 as an example according to the present invention that provides an alternative subtitle instead of a default subtitle available in the original media source. FIG. 7 is a flowchart for illustrating operation of the media player apparatus 60. The media player apparatus 60 has a tuner 600, a MPEG decoder 602, a subtitle engine 604 and a mixer 606 for playing a media source 621. An example of the media source 621 is a television broadcast stream containing a multimedia data stream, e.g. the video portion 63 and a reference subtitle stream portion 631. Another example of the media source 621 is a DVD or a Blu-ray disc with a limited number of subtitles, e.g. having English, Spanish and French subtitles but no Korean subtitle available within the DVD.

In digital television systems like ATSC, the reference subtitle stream portion 631 and the multimedia data stream portion 63 are transmitted together and a terminal receiver, based on user configuration, selects whether to render the reference subtitle stream portion 631 together with the multimedia data stream portion 63 directly. Even the reference subtitles are directly overlapped on the multimedia data stream portion 63, or the reference subtitles are transmitted as pictures instead of text, it is applicable to parse out the reference subtitles into text stream using optical character recognition skills.

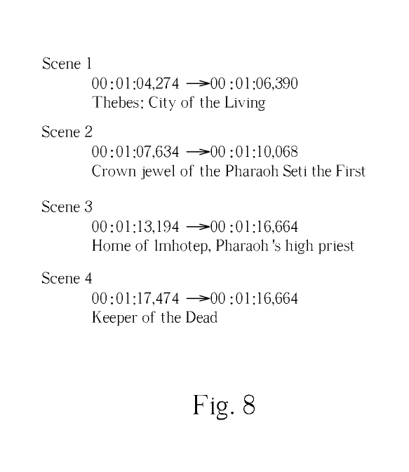

After the tuner 600 receives the media source 621, the decoder extracts the reference subtitle stream 623 from the media source (step 702). FIG. 8 illustrates an illustrative example of the reference subtitle stream 623, which is divided into a plurality of reference subtitle segments, i.e. Scene 1 to Scene 4. The reference subtitle stream 623 is produced and synchronized by providers of the media source 621. In the example illustrated in FIG. 8, timestamps, e.g. 00:01:04.274→00:01:06.390, are used for synchronizing the reference subtitle stream 623 and the multimedia data stream 625. For example, during time period 00:01:04.274 to 00:01:06.390, a video clip of the multimedia data stream 625 is mapped to the subtitle stream “Thebes: City of the Living.”

Next, the reference subtitle stream 623 as well as an intermediate subtitle stream 627 and a substitute subtitle stream 629 are used by the subtitle engine 604 for finding a mapping relationship between the reference subtitle stream 623 and the intermediate subtitle stream 627 (step 704). In addition to the mapping relationship, an associated relationship between the intermediate subtitle stream 627 and the substitute subtitle stream 629 are also referenced so that the subtitle engine 604 is capable of generating an output subtitle stream 630 (step 706). The output subtitle stream 630 and the multimedia data stream 625 are then displayed together after being merged by the mixer 606 (step 708).

In this example, the reference subtitle stream 623 and the intermediate subtitle stream 627 are of a first language, e.g. English. The substitute subtitle stream 629 and the output subtitle stream 630 are of a second language, e.g. Spanish. The default subtitle language of the media source 621 is embedded with English subtitle. With the present invention, the actual output can be video portion 65 combined with Spanish subtitle 651. In other words, for those who do not know English and no Spanish subtitle is delivered with TV programs, they can still enjoy the TV program with the Spanish subtitle provided according to the present invention.

The following illustrates how to find the mapping relationship and the associated relationship.

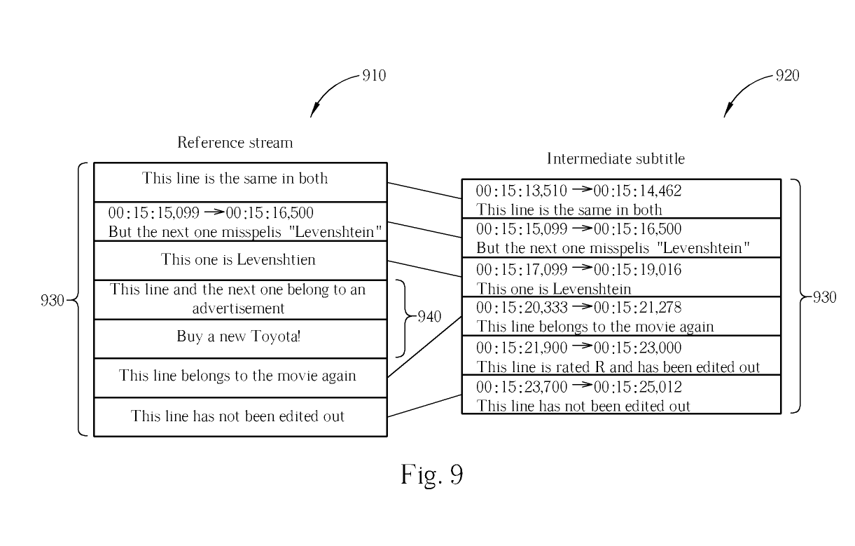

FIG. 9 illustrates an example of the mapping relationship between the reference subtitle stream 910 and the intermediate subtitle stream 920. In the example, the reference subtitle stream 910 contains a plurality of subtitle segments 930, i.e. a series of scenes. Some of these subtitle segments also correspond to the same text strings of one intermediate subtitle stream 920 of the same language, which may be stored in a subtitle file, e.g. a SRT file, downloaded from the Internet. If the media source is TV, some subtitle segments 940 are added by the TV operator, e.g. advertisements, and are not found at the intermediate subtitle stream 920. Meanwhile, there can be some scenes cut by the TV operator. However, there are still identical subsets of strings between the reference subtitle stream 910 and the intermediate subtitle stream 920. Therefore, various known string mapping algorithms can be used for matching the reference subtitle stream 910 and the intermediate subtitle stream 920. An example of the string comparison is using Levenshtein distance.

According to Wikipedia's definition available at http://en.wikipedia.org/wiki/Levenshtein_distance, “In information theory, the Levenshtein distance or edit distance between two strings is given by the minimum number of operations needed to transform one string into the other, where an operation is an insertion, deletion, or substitution of a single character. It is named after Vladimir Levenshtein, who considered this distance in 1965. It is useful in applications that need to determine how similar two strings are, such as spell checkers.

For example, the Levenshtein distance between “kitten” and “sitting” is 3, since these three edits change one into the other, and there is no way to do it with fewer than three edits:

kitten→sitten (substitution of ‘k’ for ‘s’)

sitten→sittin (substitution of ‘e’ for ‘i’)

sittin→sitting (insert ‘g’ at the end)

It can be considered a generalization of the Hamming distance, which is used for strings of the same length and only considers substitution edits. There are also further generalizations of the Levenshtein distance that consider, for example, exchanging two characters as an operation, like in the Damerau-Levenshtein distance algorithm.” In other words, even there are some wording differences between the reference subtitle stream 910 and the intermediate subtitle stream 920, the matches can be found by controlling the Levenshtein distance.

Therefore, if two text strings have a plurality of subsets, these subsets can be matched and identified using string comparison efficiently. In other words, the reference stream 910 which is already synchronized with a TV program can be substituted with the intermediate subtitle stream 920 so that the intermediate subtitle stream 920 can be synchronized with the TV program. In other words, the mapping relationship helps synchronize the reference subtitle stream 910 with the intermediate subtitle stream 920. Moreover, with the associated relationship between the intermediate subtitle stream and one or more substitute subtitle streams explained below, the reference subtitle stream 910 can be further synchronized with the one or more substitute subtitle streams.

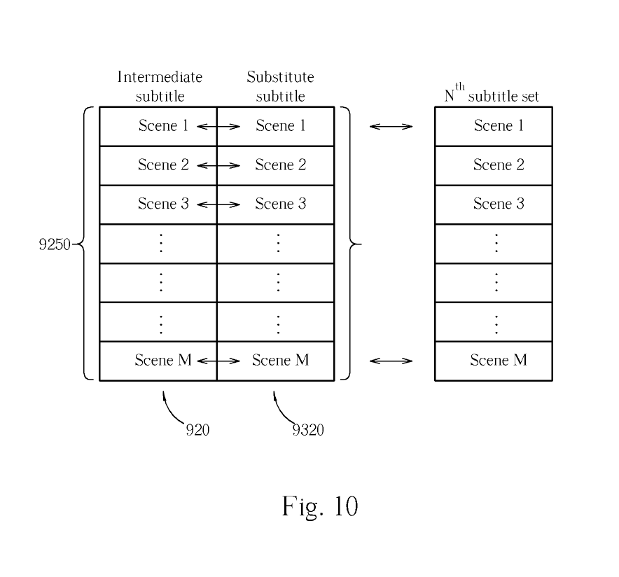

FIG. 10 illustrates an example of the associated relationship between the intermediate subtitle stream and one or more candidate subtitle streams using timestamp matching. In this example, there are N sets of candidate subtitles stored in a subtitle file 9250. Such subtitle file is available over the Internet or can be created or edited by a user. A subtitle stream is referred to as the intermediate subtitle stream 920 when it has the same language as the reference subtitle stream. One or more of the other subtitles can be selected as the substitute subtitle stream 9320. Usually, each subtitle is divided into a series of subtitle segments, e.g. scene 1 to scene M illustrated in FIG. 10. Subtitle segments among different subtitles are synchronized. A method for synchronizing these subtitles is to use a series of timestamps. A series of timestamps can be shared by all subtitles. Also, each subtitle can have its own series of timestamp and by matching the timestamp series, these subtitle can be associated for finding the “associated relationship” between the intermediate subtitle and the selected substitute subtitle. In addition to the above example, different subtitles may have different number of scenes. For instance, a sentence displayed on 2 lines in English may take 3 lines in French and therefore can be cut into 2 scenes, i.e. the French subtitle having one scene with 2 lines and another scene with 1 line. The above mentioned algorithm can also be modified to apply on such subtitle arrangement. On FIG. 10 for instance, the substitute subtitle may have M′ scenes and the Nth subtitle set may have Mn scenes.

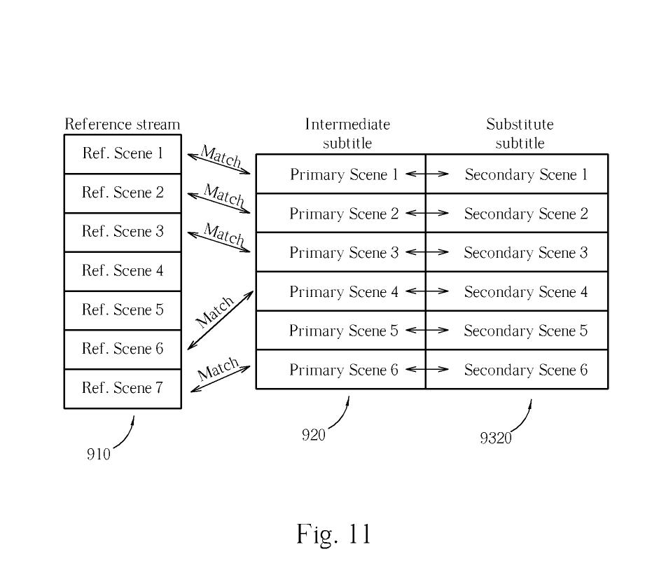

FIG. 11 illustrates an example of combining the mapping relationship and the associated relationship to synchronize the substitute subtitle stream 9320 and the reference subtitle stream 910 via the intermediate subtitle stream 920. Thus, the substitute subtitle stream 9320, if available, can be efficiently synchronized with the reference subtitle stream 910 and provided to a user, e.g. using string comparison.

Compared with translation directly from the reference subtitle stream which usually takes certain resources, the method recited above for providing a substitute subtitle stream is more efficient, and thus requires lower computation power and complexity. Even translation is adopted, the invention can be used for speeding translation. For example, the subtitle can be mapped to a language that is easier to be translated by the above skill.

There are many ways for supplying the intermediate subtitle stream and the substitute subtitle stream. For example, the intermediate subtitle stream and the substitute subtitle stream can be stored in an electronic file, e.g. an SRT file or in a database. Alternatively, it is not necessary to put the intermediate subtitle and the substitute subtitle in the same file or database. Moreover, another subtitle can be used for indirectly connect the intermediate subtitle and the substitute subtitle. For example, a first file contains an English subtitle and a Spanish subtitle. A second file contains a Mexican subtitle and a French subtitle. Using the first file, a reference English subtitle is associated with the Spanish subtitle. Further, by performing string comparison, the Spanish subtitle can be associated to the Mexican subtitle, which is synchronized with the French subtitle using timestamp. In such case, the reference subtitle is finally mapped to the French subtitle, even the substitute subtitle, i.e. the French subtitle, and the intermediate subtitle, i.e. the English subtitle, are not in the same file, the subtitle mapping and replacing is still applicable.

The media player apparatus 60 can also be equipped with a network interface, e.g. a wire/wireless network card, for connecting to a remote server for accessing the intermediate and substitute subtitle streams. Programs and/or control logic circuits can also be designed for parsing TV program name from a broadcast stream and automatically search necessary subtitles, i.e. the primary and substitute subtitle streams, from the Internet.

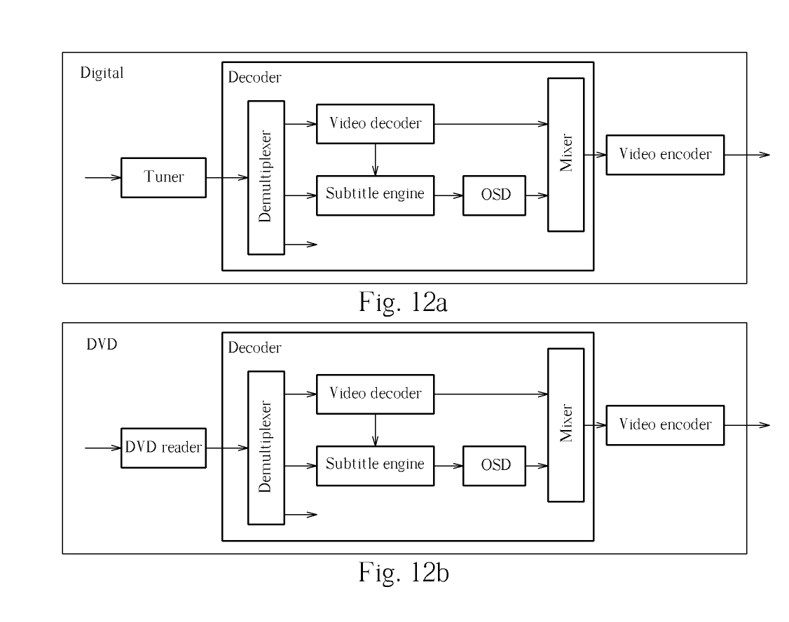

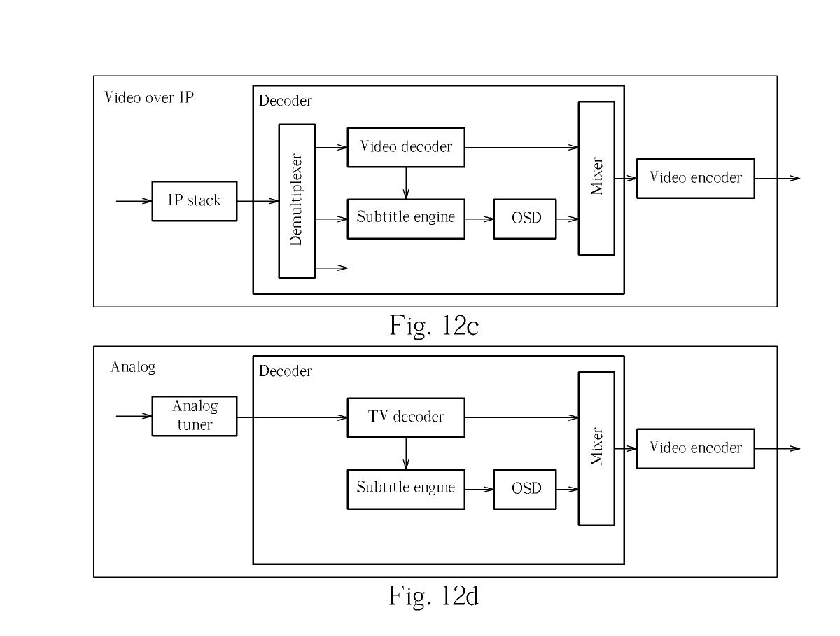

After above explanation, persons skilled in the art should be capable to implement the inventive concept. In addition to the embodiments and examples illustrated above, FIGS. 12a, 12b, 12c and 12d respectively illustrates additional design diagrams of TV, DVD, Video over IP and analog cable applications.

The replacement from the reference subtitle to substitute subtitle can be performed offline or in real time. In other words, if the hardware/software solution is powerful enough, the replacement can be performed in real time. Otherwise, the inventive concept can also be combined with recorded video files.

In the example illustrated above, the reference subtitle stream and the intermediate subtitle stream are of the same language, i.e. the first language. However, the first language can have two subsidiary languages, that is, the reference subtitle stream and the intermediate subtitle stream do not have to be of the exactly same language. For example, the reference subtitle stream is of American English and the intermediate subtitle stream is of Britain English. A conversion between the American English and the Britain English is applied before matching strings between the reference subtitle stream and the intermediate subtitle stream. Such application can be used on similar languages traditional Chinese and simplified Chinese, and other languages having similar characteristics. Furthermore, the term “language” can be referred to more general meaning when used in the invention. For example, the first language refers to English dialogues of a movie and the second language refers to director commentaries of the movie.

Moreover, an operating interface can be provided to a user to set corresponding configurations, e.g. setting default secondary language, TV station names, areas, remote server address and access codes, caption size, displaying both the reference subtitle and the substitute subtitle, displaying more than one substitute subtitles, etc.

Besides, the procedures described above can be written into corresponding computer programs and provided to customers via optical discs or via a server.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for playing a media source, comprising:
extracting a reference subtitle stream from the media source, the reference subtitle stream being synchronized with a multimedia data stream of the media source;
matching the reference subtitle stream to a substitute subtitle stream from a subtitle source for generating an output subtitle stream; and
playing the multimedia data stream and the output subtitle stream synchronously.

2. The method of claim 1, wherein the step of matching comprises:
associating the reference subtitle stream to a intermediate subtitle stream from the subtitle source using string comparison; and
associating the intermediate subtitle stream to the substitute subtitle stream using timestamp synchronization.

3. The method of claim 2, wherein the intermediate subtitle stream and the reference subtitle stream are of a first language and the substitute subtitle stream is of a second language.

4. The method of claim 2, wherein the intermediate subtitle stream is of a first subsidiary language of the first language and the reference subtitle stream is of a second subsidiary language of the first language and the method further comprises:
associating the first subsidiary language and the second subsidiary language when associating the reference subtitle stream and the intermediate subtitle stream.

5. The method of claim 2, wherein the subtitle source are data from a remote server, and the method further comprises:
connecting to the remote server for retrieving the intermediate subtitle stream and the substitute subtitle stream.

6. The method of claim 1, wherein the step of matching is performed by associating timestamps of the reference subtitle stream and the substitute subtitle stream.

7. The method of claim 1, wherein the multimedia data stream includes a video stream.

8. The method of claim 1, wherein the media source includes a DVD disc.

9. The method of claim 1, wherein the media source includes a video over IP stream.

10. The method of claim 1, wherein the media source includes a television broadcast signal.

11. The method of claim 1, wherein the media source includes a hard disk d rive.

12. The method of claim 1, wherein the subtitle source is an electronic file.

13. The method of claim 1, wherein the subtitle source is a subtitle database.

14. The method of claim 1, wherein the step of matching is performed offline.

15. The method of claim 1, wherein the step of matching is performed in real time while data are received from the media source.

16. A media player apparatus for playing a media source, comprising:
a de-multiplexer for extracting a reference subtitle stream from the media source, the reference subtitle stream being synchronized with a multimedia data stream of the media source;
a subtitle engine for generating an output subtitle stream by mapping the reference subtitle stream to a substitute subtitle stream from a subtitle source; and
a mixer for merging the multimedia data stream and the output subtitle.

17. The media player apparatus of claim 16, wherein to perform the matching from the reference subtitle stream, the subtitle engine associates the reference subtitle stream to a intermediate subtitle stream from the media source using string comparison and further associates the intermediate subtitle stream to the substitute subtitle stream for generating the output subtitle stream using timestamps.

18. The media player apparatus of claim 16, wherein the subtitle engine associates the reference subtitle stream to the substitute subtitle stream using timestamps.

19. The media player apparatus of claim 16, further comprising:
a tuner for receiving the media source from a broadcast source.

20. The media player apparatus of claim 16, further comprising:
a network interface for receiving the media source from a server.

21. The media player apparatus of claim 16, wherein the media source is a hard disk.
